(19) United States
(12) Patent Application Publication
(10) Pub. No.: US 2018/0201097 A1
(43) Pub. Date: Jul. 19, 2018

(54) AIR CONDITIONING COMPRESSOR CONTROL FOR START-STOP VEHICLES

(71) Applicant: Toyota Motor Engineering & Manufacturing North America, Inc., Erlanger, KY (US)

(72) Inventors: David W. Cosgrove, Royal Oak, MI (US); Hidekazu Hirabayashi, Ann Arbor, MI (US); Stefan Young, Ann Arbor, MI (US)

(21) Appl. No.: 15/410,137

(22) Filed: Jan. 19, 2017

(51) Int. Cl. B60H 1/32; B60H 1/00

(52) U.S. Cl. CPC B60H 1/322; B60H 1/00328; B60H 1/3211; B60H 1/00778; B60H 1/00878; B60H 1/00764

(57) ABSTRACT

A vehicle heating, ventilating, and air conditioning (HVAC) system can be configured for operation in a vehicle having a start-stop system. The start-stop system can automatically switch a vehicle engine between ON and OFF states to save fuel economy. A compressor within the HVAC system can be controlled based on a request to switch the engine from an OFF state to an ON state. It can be determined whether an air conditioning system is in an active state, whether the engine is in an OFF state due to the start-stop system, whether there is an engine OFF cancel request to switch the engine to an ON state, and whether the engine OFF cancel request is due to an HVAC request. If the engine OFF cancel request is not due to an HVAC request, the engine can be switched to an ON state while the compressor remains in an OFF state.

### FIELD

The subject matter described herein relates in general to vehicle heating, ventilating, and air conditioning (HVAC) systems within start-stop vehicles and, more particularly, to the control of a compressor within such systems.

### BACKGROUND

Vehicles can include start-stop systems that automatically shut down and restart a vehicle engine to reduce the amount of time the engine spends idling. Such systems can reduce fuel consumption and emissions of the engine. These vehicles can also include heating, ventilating, and air conditioning (HVAC) systems to change the temperature of an interior passenger compartment. The HVAC systems can include air conditioning (AC) systems to cool the interior passenger compartment by cycling a refrigerant fluid through a refrigeration cycle. For example, a compressor can be used to compress refrigerant vapor to a higher pressure. The compressed refrigerant can be routed through a condenser, where the refrigerant can be cooled and condensed. The cooled refrigerant can be routed to an evaporator where the refrigerant evaporates back to a vapor state as the refrigerant receives heat from air blown by a blower. The compressor can be operatively connected to the vehicle engine such that the compressor is operated when the engine is in an ON state.

### SUMMARY

In one example, the present disclosure is directed to a method of controlling an AC compressor in a vehicle having a start-stop system. The AC compressor is operable in at least one of an ON state and an OFF state and the start-stop system is operable to switch an engine of the vehicle between an ON state and an OFF state. The method includes determining whether the engine is switched to an OFF state due to the start-stop system while the AC compressor is in an ON state, the AC compressor is switched to an OFF state when the engine is switched to the OFF state. The method further includes determining whether an engine OFF cancel request is generated to switch the engine to an ON state. If the engine OFF cancel request is generated, the method determines whether the engine OFF cancel request is due to a heating, ventilating, and air conditioning (HVAC) request. If the engine OFF cancel request is not due to an HVAC request, the method includes switching the engine to the ON state while the AC compressor remains in the OFF state

In another example, the present disclosure is directed to a method of controlling an AC compressor in a vehicle having a start-stop system. The method includes determining whether the AC compressor is in an ON state. Responsive to determining that the AC compressor is in the ON state, the method determines whether an engine of the vehicle is switched to an OFF state due to the start-stop system, the AC compressor being switched to an OFF state when the engine is switched to the OFF state. The method further includes determining whether an engine OFF cancel request is generated to switch the engine to an ON state. Responsive to determining that there is a generated engine OFF cancel request, the method determines whether the engine OFF cancel request is due to a heating, ventilating, and air conditioning (HVAC) request. Responsive to determining that the engine OFF cancel request is not due to an HVAC request, the method includes switching the engine to the ON state while the AC compressor remains in the OFF state.

In yet another example, the present disclosure is directed to a vehicle HVAC system operable within a vehicle having a start-stop system. The system includes one or more controllers operatively connected to a compressor and an engine. The system further includes a memory operatively connected to the one or more controllers. The memory stores instructions that, when executed by the one or more controllers, cause the one or more controllers to determine whether the engine is switched to an OFF state due to the start-stop system while the compressor is in an ON state, the compressor being switched to an OFF state when the engine is switched to the OFF state. The instructions also cause the one or more controllers to determine whether there is an engine OFF cancel request generated to switch the engine to an ON state. If there is a generated engine OFF cancel request, the instructions can cause the one or more controllers to determine whether the engine OFF cancel request is due to a heating, ventilating, and air conditioning (HVAC) request. If the engine OFF cancel request is not due to an HVAC request, the instructions cause the one or more controllers to switch the engine to the ON state while the compressor remains in the OFF state.

### BRIEF DESCRIPTION OF THE DRAWINGS

FIG. 1 is a block diagram illustrating an example of a vehicle having a start-stop system and a heating, ventilating, and air conditioning (HVAC) system.

FIG. 2 is a schematic diagram illustrating an example of an HVAC system.

FIG. 3 is a flow diagram illustrating an example of a method of controlling an air conditioning compressor in a vehicle having a start-stop system.

### DETAILED DESCRIPTION

This detailed description relates to the operation of HVAC systems in vehicles having start-stop systems. The start-stop systems can switch a vehicle engine between an ON state and an OFF state, which can, for example, reduce fuel consumption. Systems can determine whether the engine of the vehicle is switched to an OFF state due to the start-stop system while an air conditioning (AC) compressor is in an ON state. The AC compressor can be switched to an OFF state when the engine is switched to the OFF state. Systems can determine whether there is an engine OFF cancel request to switch the engine to an ON state. If it is determined that there is an engine OFF cancel request, systems can determine whether the engine OFF cancel request is due to an HVAC request. If the engine OFF cancel request is not due to an HVAC request, the engine can be switched to an ON state while the compressor remains in an OFF state. If the engine OFF cancel request is due to an HVAC request, both the engine and the compressor can be switched to the ON state. The present detailed description relates to systems and methods that incorporate one or more of such features. In at least some instances, such systems and methods can reduce the required torque to restart the engine resulting in reduced fuel consumption.

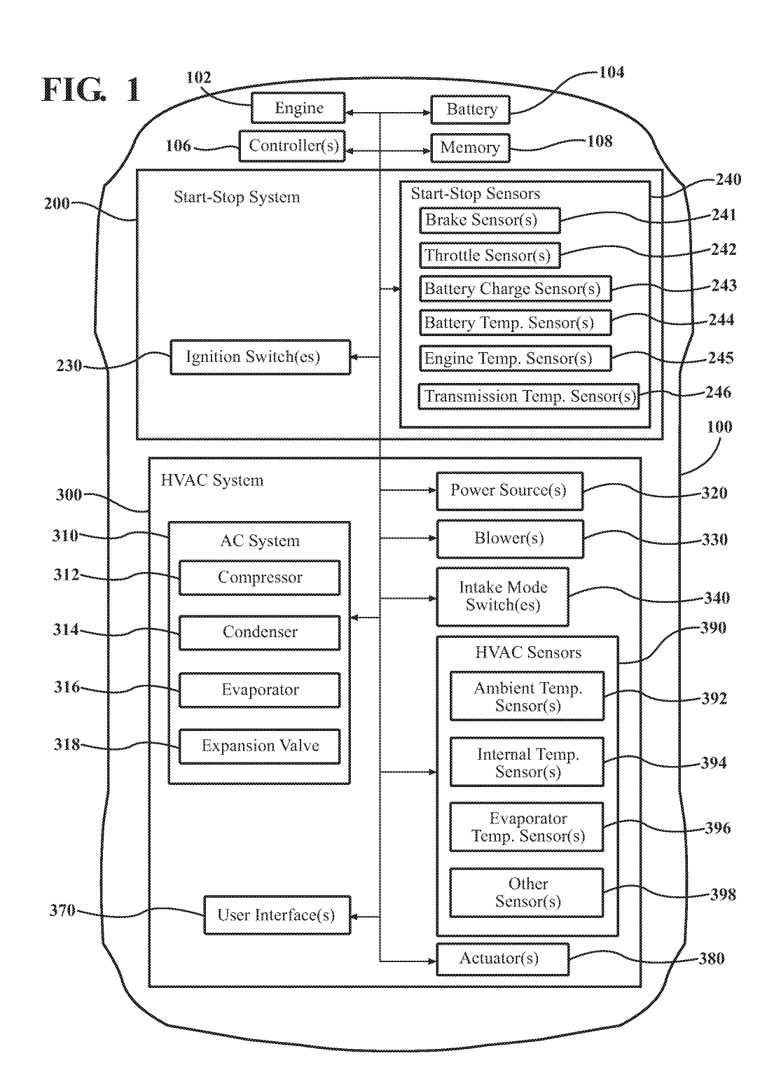

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-3, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example a vehicle 100 is shown. As used herein, “vehicle” means any form of motorized transport. In one or more implementations, the vehicle 100 can be an automobile. While arrangements will be described herein with respect to automobiles, it will be understood that embodiments are not limited to automobiles. In some implementations, the vehicle 100 may be a watercraft, an aircraft or any other form of motorized transport.

Some of the possible elements of the vehicle 100 are shown in FIG. 1 and will now be described. It will be understood that it is not necessary for the vehicle 100 to have all of the elements shown in FIG. 1 or described herein. The vehicle 100 can have any combination of the various elements shown in FIG. 1. Further, the vehicle 100 can have additional elements to those shown in FIG. 1. In some arrangements, vehicle 100 may not include one or more of the elements shown in FIG. 1. Further, while the various elements are shown as being located within the vehicle 100 in FIG. 1, it will be understood that one or more of these elements can be located external to the vehicle 100. Further, the elements shown may be physically separated by large distances. In one or more arrangements, the vehicle 100 can include a start-stop system 200 and a heating, ventilating, and air conditioning (HVAC) system 300.

The vehicle 100 can include an engine 102 to generate power. As used herein, “engine” can include any component or group of components of the vehicle 100 that generates and/or transfers power used by the vehicle 100 for movement. The engine can be any suitable type of engine or motor, now known or later developed. For instance, the engine can be an internal combustion engine, an electric motor, a steam engine, and/or a Stirling engine, just to name a few possibilities. In some embodiments, the engine can include a plurality of engine types. For instance, a gas-electric hybrid vehicle can include a gasoline engine and an electric motor.

The engine 102 can include an energy source to at least partially power the engine 102. The engine 102 can be configured to convert energy from the energy source into mechanical energy. Examples of energy sources include gasoline, diesel, propane, hydrogen, other compressed gas-based fuels, ethanol, solar panels, batteries, and/or other sources of electrical power. Alternatively or in addition, the energy source can include fuel tanks, batteries, capacitors, and/or flywheels. In some embodiments, the energy source can be used to provide energy for other systems of the vehicle 100.

The vehicle 100 can include a battery 104 to store electrical energy for the vehicle 100. The battery 104 can provide electrical energy to power a variety of vehicle systems. For instance, the battery 104 can power a vehicle ignition system, lights, on-board electronics, as well as any other electronic device connected within the vehicle 100. In one or more arrangements, the battery 104 can be a lead-acid battery including six 2.1 volt cells to provide a nominally 12-volt battery system. The battery 104 can be configured for recharging by the engine 102. In one or more arrangements, the battery 104 can provide an energy source for the engine 102.

The vehicle 100 can include one or more controllers 106. As used herein, “controller” means any component or group of components that are configured to execute any of the processes described herein or any form of instructions to carry out such processes or cause such processes to be performed. The controller(s) 106 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a processor. The controller(s) 106 can include at least one hardware circuit (e.g., an integrated circuit) configured to carry out instructions contained in program code. In arrangements in which there is a plurality of controllers 106, such controllers can work independently from each other or one or more controllers can work in combination with each other. In one or more arrangements, the controller(s) 106 can include a main processor of the vehicle 100. For instance, the controller(s) 106 can include an electronic control unit (ECU). In some arrangements, the controller(s) 106 can be integrated within the start-stop system 200 and/or the HVAC system 300. For instance, the controller(s) 106 can include one or more start-stop controllers and/or one or more HVAC controllers. Alternatively or in addition, the controller(s) 106 can be operatively connected to one or more elements of the start-stop system 200 and/or the HVAC system 300. The term “operatively connected,” as used throughout this description, can include direct or indirect connections, including connections without direct physical contact. Although shown as an element of the vehicle 100, the controller(s) 106 can include remote controllers in communication with one or more elements of the vehicle 100.

The vehicle 100 can include memory 108 and/or one or more other data stores for storing one or more types of data. The memory 108 can include volatile and/or non-volatile memory. Examples of suitable memory 108 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 108 can be a component of the controller(s) 106, or the memory 108 can be operatively connected to the controller(s) 106 for use thereby. In one or more arrangements, the memory 108 can include instructions to allow the controller 106 to control one or more elements of the start-stop system 200 and/or the HVAC system 300. In some arrangements, the memory 108 can be integrated within the start-stop system 200 and/or the HVAC system 300. For instance, the memory 108 can include start-stop memory and/or HVAC memory. Alternatively or in addition, the memory 108 can be operatively connected to one or more elements of the start-stop system 200 and/or the HVAC system 300.

The vehicle 100 can include the start-stop system 200 to automatically shut down and restart the engine 102. In some arrangements, the start-stop system 200 can reduce energy source (such as fuel) consumption when power requirements of the vehicle 100 decrease. For example, the start-stop system 200 can shut down the engine 102 when the vehicle 100 is stopped or coasting. The start-stop system 200 can be operable to switch the engine 102 between an ON state and an OFF state. As used herein, “OFF state” can include configurations of the engine 102 when energy source consumption is reduced and/or discontinued. For example, an OFF state can include when the engine 102 is not burning fuel or burning a reduced amount of fuel. As used herein, “ON state” can include configurations of the engine 102 when consuming an energy source such as fuel.

The controller(s) 106 can be configured to cause, directly or indirectly, one or more elements of the start-stop system 200 to be activated or to be deactivated. As used herein, “cause” or “causing” means to make, force, compel, direct, command, instruct, and/or enable an event or action to occur or at least be in a state where such event or action may occur, either in a direct or indirect manner. In one or more arrangements, the controller(s) 106 can be a vehicle electronic control unit (ECU).

The start-stop system 200 can include one or more ignition switches 230 for changing a state of the engine 102. For example, the ignition switch(es) 230 can be configured to shut down and/or restart the engine 102 by switching the engine 102 between the OFF state and the ON state.

The start-stop system 200 can include one or more start-stop sensors 240. “Sensor” means any device, component and/or system that can detect, determine, assess, monitor, measure, quantify and/or sense something. The one or more sensors can be configured to detect, determine, assess, monitor, measure, quantify and/or sense in real-time. As used herein, the term “real-time” means a level of processing responsiveness that a user or system senses as sufficiently immediate for a particular process or determination to be made, or that enables the processor to keep up with some external process.

In arrangements in which there are a plurality of start-stop sensors 240, the sensors can work independently from each other. Alternatively, two or more of the sensors can work in combination with each other. In such case, the two or more sensors can form a sensor network. The start-stop sensors 240 can be operatively connected to the controller(s) 106, the memory 108, and/or other elements of the start-stop system 200 and/or the HVAC system 300 (including any of the elements shown in FIG. 1). The start-stop sensors 240 can include any suitable type of sensor. Various examples of different types of sensors will be described herein. However, it will be understood that the embodiments are not limited to the particular sensors described.

The start-stop sensors 240 can include one or more brake sensors 241. The brake sensor(s) 241 can be configured to sense one or more attributes about a vehicle braking system. The brake sensor(s) 241 can be any suitable sensor, including mechanical, and/or electrical sensors that can detect, determine, assess, monitor, measure, quantify, and/or sense a status of a vehicle braking system (not shown). In one or more arrangements, the brake sensor(s) 241 can sense whether or not one or more brakes, such as a brake at a wheel of the vehicle 100, are being applied. Alternatively or in addition, the brake sensor(s) 241 can sense whether or not a brake input from an occupant of the vehicle 100 is being applied. For example, the brake sensor(s) 241 can sense whether a brake pedal is being depressed within the vehicle 100.

The start-stop sensors 240 can include one or more throttle sensors 242. The throttle sensor(s) 242 can be configured to sense one or more attributes about a throttle system. The throttle sensor(s) 242 can be any suitable sensor, including mechanical and/or electrical sensors that can detect, determine, assess, monitor, measure, quantify, and/or sense a status of a throttle system (not shown). In one or more arrangements, the throttle sensor(s) 242 can include a throttle position sensor (TPS) that can sense a throttle position. Alternatively or in addition, the throttle sensor(s) 242 can include an accelerator pedal sensor and/or a wide open throttle (WOT) sensor.

The start-stop sensors 240 can include one or more battery charge sensor(s) 243. The battery charge sensor(s) 243 can be configured to sense one or more attributes about an electrical charge of the battery 104. The battery charge sensor(s) 243 can be any suitable sensor, including mechanical and/or electrical sensors that can detect, determine, assess, monitor, measure, quantify, and/or sense a charge status of the battery 104.

The start-stop sensors 240 can include one or more temperature sensors. The temperature sensors can be configured to sense a temperature of a certain portion of the vehicle 100. For example, the temperature sensors can include one or more battery temperature sensors 244, one or more engine temperature sensors 245, and/or one or more transmission temperature sensors 246. The temperature sensor(s) can be any suitable sensor, including mechanical, electrical, and/or integrated circuit temperature sensors that can detect, determine, assess, monitor, measure, quantify, and/or sense a temperature. For example, the temperature sensor(s) can include a mechanical thermometer, a bimetal sensor, a thermistor, a thermocouple, a resistance thermometer, and/or a silicon bandgap sensor.

In one or more arrangements, the start-stop system 200 can automatically switch the engine 102 between the ON and OFF states based on information received by the start-stop sensors 240. For instance, the controller(s) 106 can cause the switching based on the status of one or more vehicle systems sensed by the start-stop sensors 240.

In some arrangements, the engine 102 can be switched to the OFF state when a brake is being applied and no throttle is being applied. Further, the engine 102 can be switched to the OFF state when a battery charge is above a predetermined threshold. In yet another example, the engine 102 can be switched to the OFF state when the temperature of the battery, engine, and/or transmission are at acceptable levels. Alternatively or in addition, the status of these systems can be used in determining when to switch the engine 102 back to the ON state.

In one or more arrangements, the start-stop system 200 can switch the engine 102 to the OFF state upon generating an engine OFF request. Further, the start-stop system 200 can switch the engine 102 from the OFF state to the ON state upon generating an engine OFF cancel request. In some arrangements, the engine OFF request and/or the engine OFF cancel request can be generated by one or more vehicle controllers, such as the controller(s) 106. The engine OFF request and the engine OFF cancel request can be based on the vehicle systems described herein. For example, an engine OFF request or an engine OFF cancel request can be generated based on a status of one or more of the braking system, the throttle system, one or more aspects of the braking system, the throttle system, the battery, the engine 102, the transmission, and/or the HVAC system 300.

In some arrangements, the engine OFF cancel request can be generated when a brake is no longer applied and/or a throttle is being applied. Further, the engine OFF cancel request can be generated when a battery charge is below a predetermined threshold. In yet another example, the engine OFF cancel request can be generated when the temperature of the battery, engine, and/or transmission are not at acceptable levels. The engine OFF cancel request can also be generated based on an HVAC request, described in further detail below.

The HVAC system 300 can be configured to change the environment or climate of an interior compartment of the vehicle 100. Some of the possible elements of the HVAC system 300 are shown in FIG. 1 and will be described. It will be understood that it is not necessary for the HVAC system 300 to have all of the elements shown in FIG. 1 or described herein. The HVAC system 300 can have any combination of the various elements shown in FIG. 1. Further, the HVAC system 300 can have additional elements to those shown in FIG. 1.

The HVAC system 300 can include an air conditioning (AC) system 310. The AC system can have any configuration to allow for cooling and/or humidity control for at least a portion of the vehicle 100. In one or more arrangements, the AC system 310 can include a refrigerant (not shown), a compressor 312, a condenser 314, an evaporator 316, and/or an expansion valve 318. The various elements of the AC system 310 can be arranged in any suitable manner and/or can be operatively connected to each other in any suitable manner.

The compressor 312 can be configured to direct or facilitate the movement of refrigerant throughout the AC system 310. In one or more arrangements, the compressor 312 can increase the pressure of the refrigerant vapor, such as by reducing a volume of the vapor. The higher pressure of the refrigerant vapor can increase the temperature of the refrigerant.

The compressor 312 can have any suitable configuration for the AC system 310. As non-limiting examples, the compressor 312 can include a rotary compressor, a reciprocating compressor, a centrifugal compressor, and/or an axial compressor. The compressor 312 can be powered by any suitable power source within the vehicle 100. In one or more arrangements, the compressor 312 can be coupled to, and powered by, the engine 102. For example, a belt can be used to transfer rotational energy from the engine 102 to the compressor 312. In one or more arrangements, the compressor 312 can be a fixed compressor. As used herein, “fixed compressor” or “fixed displacement compressor” can include any compressor having a constant pumping capacity. Alternatively or in addition, the compressor 312 can be a variable compressor. As used herein, “variable compressor” or “variable displacement compressor” can include any compressor configured to vary a pumping capacity over time.

In one or more arrangements, the compressor 312 can be switched between an ON state and an OFF state. For instance, the compressor 312 can be configured to increase the pressure of the refrigerant while in an ON state. In some arrangements, the compressor 312 can be in an ON state while being powered by the engine 102.

The condenser 314 can be configured to cool and condense the refrigerant to a liquid state. The condenser 314 can have any suitable configuration for the AC system 310. In one or more arrangements, the condenser 314 be any form of a heat exchanger. For example, the condenser 314 can include coiled tubing. In some arrangements, fins can be connected to the tubing to increase a surface area of a material that is in contact with the refrigerant. In one or more arrangements, the condenser 314 can be configured to allow a fluid, such as air, to be directed through the condenser 314. For example, a fan can be operated in close proximity to the condenser to blow air across the coils and/or fins.

The evaporator 316 can be configured to allow and/or cause the transition of a refrigerant from a liquid state to a gaseous state. The evaporator 316 can allow heat transfer between the refrigerant and air surrounding the evaporator 316. In one or more arrangements, the evaporator 316 can include coiled tubes for the refrigerant to be routed through. Hotter air can be blown across the evaporator 316. In one or more arrangements, the air moving across the evaporator 316 heats the refrigerant to a warmer temperature and ultimately evaporating the refrigerant from a liquid state to a gaseous state. The air being blown across the evaporator 316 can be cooled and routed into the passenger compartment of the vehicle 100.

The expansion valve 318 can be configured to facilitate change in pressures of the refrigerant. For instance, the expansion valve 318 can be located between the condenser 314 and the evaporator 316. In one or more arrangements, the expansion valve 318 can be configured to allow the liquid refrigerant to undergo an abrupt decrease in pressure and decrease in temperature as the refrigerant moves from the condenser 314 to the evaporator 316.

The HVAC system 300 can include one or more power sources 320 to provide mechanical or electrical power to one or more elements of the HVAC system 300. In one or more arrangements, the power source(s) 320 can include the engine 102 and/or the battery 104. Alternatively or in addition, the power source(s) 320 can include other power sources. For example, the power source(s) 320 can include additional batteries and/or generators.

The HVAC system 300 can include one or more blowers 330 to direct and/or cause the movement of air or other fluid/gas. As used herein, “air” can include any gaseous fluid. For example, air can include environmental gas in and/or around the vehicle 100. The blower(s) 330 can be configured to direct and/or cause the movement of air into a passenger compartment of the vehicle 100. In one or more arrangements, the blower(s) 330 can be configured to move air across the evaporator 316 when the AC system 310 is being operated. In one or more arrangements, the blower(s) 330 can include a blower motor and one or more fans to move a quantity of air past the evaporator 316 and through air ducts into the passenger compartment of the vehicle 100. For instance, the blower(s) 330 can direct air over tubing and/or coils of the evaporator 316 to allow the refrigerant flowing through the evaporator 316 to remove heat from the air. In one or more arrangements, the blower(s) 330 can be powered by the engine 102, the battery 104, and/or the power source(s) 320.

The HVAC system 300 can include one or more intake mode switches 340 to control the source of air being introduced to the HVAC system 300 and/or the vehicle 100. In one or more arrangements, the intake mode switch(es) 340 can be configured to allow the selection of a source of air being introduced to the blower(s) 330. For instance, the source of air can be outside of a passenger compartment and/or outside of the vehicle 100, referred to as “fresh mode air source”. Additionally, the source of air can be within the passenger compartment, referred to as “recirculation mode air source.” In one or more arrangements, the intake mode switch(es) 340 can be operated to change the air source selection between a fresh mode air source, a recirculation mode air source, and/or a mix of both modes.

The HVAC system 300 can include one or more user interface(s) 370. In one or more arrangements, the user interface(s) 370 can include an input system and/or an output system. An “input system” includes any device, component, system, element or arrangement or groups thereof that enable information/data to be entered into a machine. The input system can receive an input from a vehicle occupant (e.g. a driver or a passenger). Any suitable input system can be used, including, for example, a keypad, display, touch screen, multi-touch screen, button, joystick, mouse, trackball, microphone and/or combinations thereof. An “output system” includes any device, component, system, element or arrangement or groups thereof that enable information/data to be presented to a vehicle occupant (e.g. a person, a vehicle occupant, etc.). The output system can present information/data to a vehicle occupant. The output system can include a display. Alternatively or in addition, the output system may include a microphone, earphone and/or speaker. Some components of the vehicle 100 may serve as both a component of the input system and a component of the output system. In one or more arrangements, the user interface(s) 370 can include a vehicle head unit.

The vehicle 100 can include one or more actuators 380. The actuators 380 can be any element or combination of elements operable to modify, adjust and/or alter one or more components of the start-stop system 200, the HVAC system 300 and/or the vehicle 100 responsive to receiving signals or other inputs from the controller(s) 106. Any suitable actuator can be used. For instance, the one or more actuators 380 can include motors, pneumatic actuators, hydraulic pistons, relays, solenoids, and/or piezoelectric actuators, just to name a few possibilities.

The HVAC system 300 can include one or more HVAC sensors 390. The one or more HVAC sensors 390 can detect, determine, assess, monitor, measure, quantify and/or sense aspects of the HVAC system 300 in real-time. In arrangements in which there are a plurality of HVAC sensors 390, the sensors can work independently from each other. Alternatively, two or more of the sensors can work in combination with each other. In such case, the two or more sensors can form a sensor network. The HVAC sensors 390 can be operatively connected to the controller(s) 106, the memory 108, and/or other elements of the HVAC system 300 (including any of the elements shown in FIG. 1). The HVAC sensors 390 can include any suitable type of sensor. Various examples of different types of sensors will be described herein. However, it will be understood that the embodiments are not limited to the particular sensors described.

The HVAC sensors 390 can include one or more ambient temperature sensors 392. The ambient temperature sensor(s) 392 can be configured to sense an ambient temperature outside of the vehicle 100. As used herein, “ambient temperature” includes the air temperature of at least a portion of the surrounding environment of the vehicle 100. For instance, the ambient temperature can be the air temperature near an exterior portion of the vehicle 100. The ambient temperature sensor(s) 392 can be any suitable sensor, including mechanical, electrical, and/or integrated circuit temperature sensors that can detect, determine, assess, monitor, measure, quantify, and/or sense an ambient temperature. For example, the ambient temperature sensor(s) 392 can include a mechanical thermometer, a bimetal sensor, a thermistor, a thermocouple, a resistance thermometer, and/or a silicon bandgap sensor. In one or more arrangements, the ambient temperature sensor(s) 392 can be at least partially located at, on, or proximate to an exterior surface of the vehicle 100. In some arrangements, the ambient temperature sensor(s) 392 can be separate from the vehicle 100. For instance, the vehicle 100 can receive signals from an exterior ambient temperature sensor 392. In some examples, the vehicle can receive ambient temperature information from a weather service, a remote server, or application software.

The sensors 390 can include one or more internal temperature sensors 394. The internal temperature sensor(s) 394 can be configured to detect, determine, assess, monitor, measure, quantify, and/or sense an internal temperature of the vehicle 100. “Internal temperature” means an air temperature of at least a portion of a passenger compartment of a vehicle. The internal temperature sensor(s) 394 can be any suitable sensor, including mechanical, electrical, and/or integrated circuit temperature sensors. For example, the internal temperature sensor(s) 394 can include a mechanical thermometer, a bimetal sensor, a thermistor, a thermocouple, a resistance thermometer, and/or a silicon bandgap sensor.

The sensors 390 can include one or more evaporator temperature sensors 396 to detect, determine, assess, monitor, measure, quantify, and/or sense a temperature of at least a portion of the evaporator 316 of the AC system 310. The evaporator temperature sensor(s) 396 can be any suitable sensor, including mechanical, electrical, and/or integrated circuit temperature sensors. For example, the evaporator temperature sensor(s) 396 can include a mechanical thermometer, a bimetal sensor, a thermistor, a thermocouple, a resistance thermometer, and/or a silicon bandgap sensor. In one or more arrangements, the evaporator temperature sensor(s) 396 can be configured to be in direct physical contact with a portion of the evaporator 316. For instance, the evaporator temperature sensor(s) 396 can sense the temperature of an interior and/or exterior surface of the evaporator 316. Alternatively or in addition, the evaporator temperature sensor(s) 396 can be spaced from the evaporator 316. The evaporator temperature sensor(s) 396 can be provided in one or more locations relative to the evaporator 316. In some arrangements, the evaporator temperature sensor(s) 396 can be provided at a portion of the evaporator 316 known to have the coldest temperature.

In addition to the above sensors, the sensors 390 can include one or more other sensors 398. The other sensor(s) 398 can be configured to sense one or more conditions of the interior or exterior of the vehicle 100. The controller(s) 106 can use information received by the other sensor(s) 398 to determine conditions for the AC system 310. In one or more arrangements, the other sensor(s) 398 can include a humidity sensor configured to sense a humidity of an interior or exterior portion of the vehicle 100. In one or more arrangements, the other sensor(s) 398 can include a solar sensor configured to sense a solar load at portions of the vehicle 100.

In one or more arrangements, the HVAC system 300 operate components of the AC system 310 to cool down the passenger compartment of the vehicle 100. To do so, the controller(s) 106 can use information received by the HVAC sensors 390 and/or the user interface(s) 370. For instance, the controller(s) 106 can determine a target internal temperature for the passenger compartment based the user interface(s) 370, an ambient temperature, an internal temperature and/or other factors.

During operation of the HVAC system 300, the evaporator temperature can directly affect the temperature of air being introduced to the interior of the vehicle 100. For instance, the cooler the evaporator temperature, the cooler the air being introduced to the interior. With this in mind, the HVAC system 300 can be operated based on a target evaporator outlet (TEO) temperature. As used herein, “target evaporator outlet temperature” or “TEO temperature” is any desired temperature for an outlet portion of the evaporator 316 during operation of the HVAC system 300.

In one or more arrangements, the compressor 312 can be operated at least in part based on the TEO temperature. The evaporator temperature can be inversely related to the amount of fluid pumped by the compressor 312. For instance, more fluid moved by the compressor 312 can result in lower temperatures within the evaporator 316. In arrangements where the compressor 312 is a fixed compressor, the compressor 312 can be alternated between active (ON) and inactive (OFF) states. Operating the compressor 312 with longer activated periods and/or shorter deactivated periods can cool the evaporator 316 to a lower temperature. In arrangements in which the compressor 312 is a variable compressor, the evaporator temperature can be altered based on a speed of the compressor. For example, the variable compressor can be operated at a higher speed to reduce the evaporator temperature. In one or more arrangements, the controller(s) 106 can control the operation of the compressor 312 based on a TEO temperature. For instance, the controller(s) 350 can control the compressor 312 based on the TEO temperature and information received from the ambient temperature sensor(s) 392, the internal temperature sensor(s) 394, the evaporator temperature sensor(s) 396, and/or the other sensor(s) 398.

In one or more arrangements, the compressor 312 can require the engine 102 to be operating in the ON state for the compressor 312 to be in the ON state. Thus, when the engine 102 is in the OFF state during start-stop operation, the compressor 312 may not be able to be activated. In some arrangements, the HVAC system 300 can generate an HVAC request for the engine 102 to be switched from the OFF state to the ON state. The HVAC request can have any suitable form. The HVAC request can be generated by the controller(s) 106. In some arrangements, the HVAC request can be communicated to the start-stop system 200. For example, the HVAC request can be received by the controller(s) 106 and/or the HVAC request sensor(s) 247.

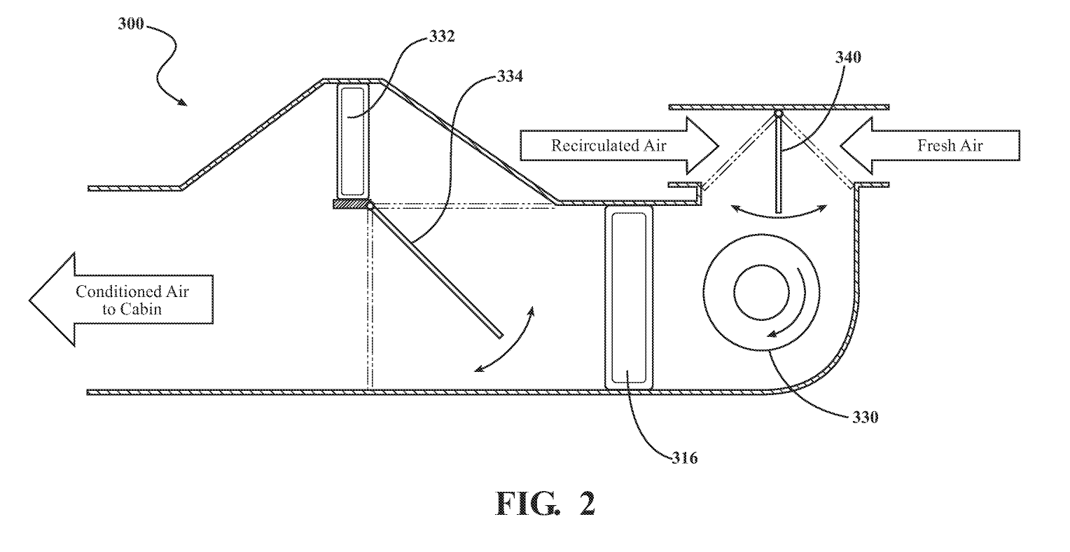

Referring now to FIG. 2, a portion of the HVAC system 300 can be shown. In one or more arrangements, the intake mode switch 340 can move to allow recirculated air and/or fresh air into the system. For example, the intake mode switch 340 can include a door that is movable between a first position that allows only fresh air to the blower 330, and a second position that allows only recirculated air to the blower 330. In one or more arrangements, the blower 330 can be activated to move air towards and through the evaporator 216. In one or more arrangements, the HVAC system 300 can include a heater core 332 to heat air traveling to the interior of the vehicle 100. An air mix door 334 can be included in the HVAC system 300 to direct air towards or away from the heater core 332.

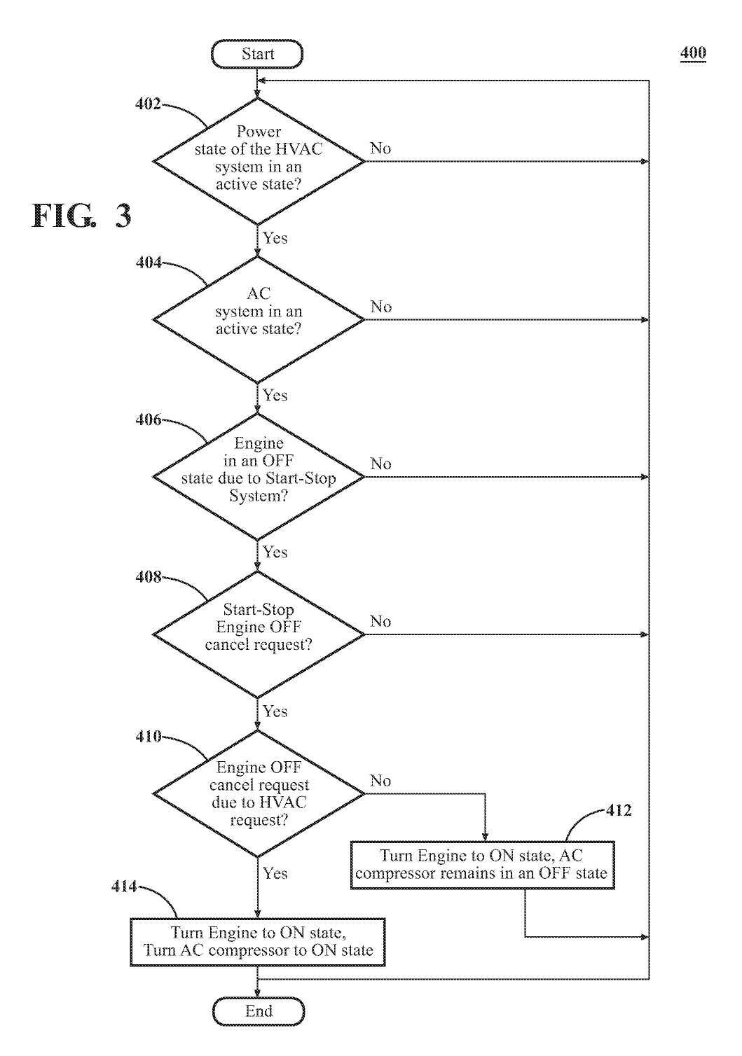

Now that the various potential systems, devices, elements and/or components of the vehicle 100 have been described, various methods to control the HVAC system 300 in a vehicle having the start-stop system 200 will now be described. Referring now to FIG. 3, an example of a controlling an AC compressor for start-stop vehicles is shown. Various possible steps of method 400 will now be described. The method 400 illustrated in FIG. 3 may be applicable to the embodiments described above in relation to FIG. 1, but it is understood that the method 400 can be carried out with other suitable systems and arrangements. Moreover, the method 400 may include other steps that are not shown here, and in fact, the method 400 is not limited to including every step shown in FIG. 3. The steps that are illustrated here as part of the method 400 are not limited to this particular chronological order. Indeed, some of the steps may be performed in a different order than what is shown and/or at least some of the steps shown can occur simultaneously.

At block 402, the method 400 can determine whether a power state of the HVAC system 300 is in an active state. The HVAC system 300 can be in an active state when any of its components (such as those shown in FIG. 1) are being operated. In one or more arrangements, the determination can be made by the controller(s) 106. If it is determined that the HVAC system 300 is not in an active state, the method 400 can return to block 402 or the method 400 can end. If it is determined that the HVAC system 300 is in an active state, the method can continue to block 404.

At block 404, it can be determined whether a power state of the AC system 310 is in an active state. The AC system 310 can be in an active state when the compressor 312 is operating and in an ON state. In one or more arrangements, the determining can be done by the controller(s) 106. If it is determined that the AC system 310 is not in an active state, the method 400 can return to block 402 or the method 400 can end. If it is determined that the HVAC system 300 is in an active state, the method can continue to block 406.

In one or more arrangements, the controller(s) 106 can determine if the HVAC system 300 and/or the AC system 310 was in an active state based on flags stored in the memory 108. As used herein, a “flag” can include any information stored in the memory 108 indicative of a status of one or more vehicle systems, such as the engine 102 and/or compressor 312. In one or more arrangements, each time an operational status of the engine 102 and/or the compressor 312 is changed (e.g., turned on or off), the status of a flag can be changed. Alternatively or in addition, each time the operational status of the engine 102 and/or the compressor 312 is changed a new flag can be generated in the memory 108.

At block 406, it can be determined whether the engine 102 is in an OFF state due to the start-stop system 200. For example, it can be determined whether a start-stop engine OFF request has been generated and the engine 102 is turned off. In one or more arrangements, the determining can be done by the start-stop controller 210, the memory 108, and/or any of the start-stop sensors 240. For example, a flag can be generated in the memory 108 when the engine 102 is switched to the OFF state due to the start-stop system 200. If it is determined that the engine 102 is not in an OFF state due to the start-stop system 200, the method 400 can return to block 402 or the method 400 can end. If it is determined that the engine is in an OFF state due to the start-stop system 200, the method can continue to block 408.

At block 408, it can be determined whether a start-stop engine OFF cancel request has been generated. In some arrangements, the start-stop engine OFF cancel request can be generated by the controller(s) 106. If it is determined that an engine OFF cancel request has not been generated, the method 400 can return to block 402 or the method 400 can end. If it is determined that an engine OFF cancel request has been generated, the method 400 can continue to block 410.

At block 410, it can be determined whether the engine OFF cancel request was due to an HVAC request. In other words, it can be determined if the engine 102 should be switched back to the ON state based at least part on the HVAC system 300. In some arrangements, the HVAC request can be based on cooling of a passenger compartment of the vehicle. For example, if a target evaporator temperature for desired cooling of the passenger compartment rises above a predetermined threshold, an HVAC request can be generated for the engine 102 and the compressor 312 to be switched to ON states. In one or more arrangements, the engine OFF cancel request can be due to factors other than the HVAC system. For instance, the engine OFF cancel request can be based on the brake status, throttle status, battery charge, battery temperature, engine temperature, and/or transmission temperature. In some arrangements, the determining can be done by the controller(s) 106 and/or the controller(s) 106 based on information from the start-stop sensor(s) 240.

If it is determined that the engine OFF cancel request is not due to an HVAC request, the method can continue to block 412. At block 412, the engine can be switched to an ON state while the compressor 312 can remain in an OFF state. In one or more arrangements, the engine 102 can be switched to the ON state via the controller(s) 106 and/or the ignition switch(es) 230.

If it is determined that the engine OFF cancel request is due to the HVAC request, the method can continue to block 414. At block 414, the engine 102 can be switched to an ON state and the compressor 312 can be switched to an ON state. In some arrangements, the compressor 312 can be switched to the ON state via the controller(s) 106.

A non-limiting example of the operation of the vehicle 100 and the HVAC system 300 in accordance with the method 400 will now be described. For purposes of this example, the vehicle 100 can include the engine 102 that is configured to be switched between an ON state and an OFF state via start-stop system 200. Further, the vehicle 100 can include an AC system 310 in an HVAC system 300 to provide cooling to a passenger compartment. The AC system 310 can include a compressor 312 powered by the engine 102.

During operation of the vehicle 100, the start-stop system 200 can be configured to switch the engine 102 to an OFF state based on one or more factors. In one or more arrangements, the start-stop system 200 can switch the engine 102 to the OFF state based on brake status, throttle status, battery charge, battery temperature, engine temperature, transmission temperature and/or HVAC status. For example, the start-stop system 200 can cause the engine 102 to be switched to an OFF state during conditions in which power from the engine 102 is not needed, such as when the vehicle 100 is stationary or coasting. In some arrangements, the controller(s) 106 can control the ON/OFF state of the engine 102 based on information from the start-stop sensors 240 and/or information stored in the memory 108.

The engine 102 can remain in the OFF state until the start-stop system 200 switches the engine 102 to an ON state based on one or more factors. In one or more arrangements, the start-stop system 200 can switch the engine 102 back to an ON state based on brake status, throttle status, battery charge, battery temperature, engine temperature, transmission temperature and/or HVAC status. For instance, the start-stop system 200 can cause the engine 102 to be switched to the ON state during conditions in which power from the engine 102 is needed. Non-limiting examples can include when acceleration of the vehicle is needed (such as starting from a stop), battery voltage is low, battery, engine, and/or transmission temperatures are high, and/or when the compressor 312 is to be operated. In some arrangements, the controller(s) 106 can control the ON/OFF state of the engine 102 based on information from the start-stop sensors 240 and/or information stored in the memory 108.

In some situations, the compressor 312 of the AC system 310 can be in operation up until the start-stop system 200 switches the engine 102 to an OFF state. The compressor 312 can be switched to an OFF state when the engine 102 is switched to the OFF state.

It can then be determined whether an engine OFF cancel request has been generated, which can then cause the start-stop system 200 to switch the engine to the ON state. Further, it can be determined whether the cancel request was due to an HVAC request. The HVAC request can be any request that the engine 102 be switched to the ON state for purposes of the HVAC system 300. In some arrangements, the HVAC request can be based on the desire to operate the compressor 312. The HVAC request can be generated by the controller(s) 106. In some arrangements, the HVAC request can be received by the controller(s) 106 and/or the HVAC request sensor(s) 247.

If it is determined that the engine OFF cancel request is not due to an HVAC request, the engine 102 can be turned to an ON state while the compressor 312 can be switched to, or remain in, the OFF state. Thus, in this situation, the compressor 312 will not be operated upon restarting of the engine 102.

If it is determined that the engine OFF cancel request is due to an HVAC request, both the engine 102 and the compressor 312 can be switched to an ON state. In such a situation, the compressor 312 will be operated upon restarting of the engine 102.

It will be appreciated that arrangements described herein can provide numerous benefits, including one or more of the benefits mentioned herein. Arrangements can prevent the vehicle from restarting the compressor with the engine after a start-stop condition if the compressor is not required for thermal comfort. This reduces required torque to restart the engine, reduces fuel consumption, lowers engine idle rotations per minute (RPMs), and/or improves noise, vibration, and harshness (NVH) characteristics.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied or embedded, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A method of controlling an air conditioning (AC) compressor in a vehicle having a start-stop system, the AC compressor being operable in at least one of an ON state and an OFF state, and the start-stop system being operable to switch an engine of the vehicle between an ON state and an OFF state, the method comprising:
determining whether the engine is switched to an OFF state due to the start-stop system while the AC compressor is in an ON state, the AC compressor being switched to an OFF state when the engine is switched to the OFF state;
determining whether an engine OFF cancel request is generated to switch the engine to an ON state;
if the engine OFF cancel request is generated, determining whether the engine OFF cancel request is due to a heating, ventilating, and air conditioning (HVAC) request; and
if the engine OFF cancel request is not due to an HVAC request, switching the engine to the ON state while the AC compressor remains in the OFF state.

2. The method of claim 1, further comprising:
if the engine OFF cancel request is due to an HVAC request, switching the engine to the ON state and switching the AC compressor to the ON state.

3. The method of claim 1, wherein the engine OFF cancel request is generated by a vehicle controller, and the engine OFF cancel request is based on information received from one or more start-stop sensors.

4. The method of claim 3, wherein the one or more start-stop sensors include one or more of a brake sensor, a throttle sensor, a battery charge sensor, a battery temperature sensor, an engine temperature sensor, and a transmission temperature sensor.

5. The method of claim 1, wherein the HVAC request is generated by a vehicle controller and is based on at least one of an ambient temperature, an internal temperature, and an evaporator temperature.

6. The method of claim 5, wherein the HVAC request is generated if the evaporator temperature becomes greater than or equal to a predetermined threshold.

7. A method of controlling an air conditioning (AC) compressor in a vehicle having a start-stop system, the method comprising:
determining whether the AC compressor is in an ON state;
responsive to determining that the AC compressor is in the ON state, determining whether an engine of the vehicle is switched to an OFF state due to the start-stop system, the AC compressor being switched to an OFF state when the engine is switched to the OFF state;
determining whether an engine OFF cancel request is generated to switch the engine to an ON state;
responsive to determining that there is a generated engine OFF cancel request, determining whether the engine OFF cancel request is due to a heating, ventilating, and air conditioning (HVAC) request; and
responsive to determining that the engine OFF cancel request is not due to an HVAC request, switching the engine to the ON state while the AC compressor remains in the OFF state.

8. The method of claim 7, further comprising:
responsive to determining that the engine OFF cancel request is due to an HVAC request, switching the engine to the ON state and switching the AC compressor to the ON state.

9. The method of claim 7, wherein the engine OFF cancel request is generated by a vehicle controller, and the engine OFF cancel request is based on information received from one or more start-stop sensors.

10. The method of claim 9, wherein the one or more start-stop sensors include one or more of a brake sensor, a throttle sensor, a battery charge sensor, a battery temperature sensor, an engine temperature sensor, and a transmission temperature sensor.

11. The method of claim 7, wherein the HVAC request is generated by a vehicle controller and is based on at least one of an ambient temperature, an internal temperature, and an evaporator temperature.

12. The method of claim 11, wherein the HVAC request is generated if the evaporator temperature becomes greater than or equal to a predetermined threshold.

13. A vehicle heating, ventilating, and air conditioning (HVAC) system operable within a vehicle having a start-stop system, the system comprising:
one or more controllers operatively connected to a compressor and an engine; and
a memory operatively connected to the one or more controllers, the memory storing instructions that, when executed by the one or more controllers, cause the one or more controllers to:
determine whether the engine is switched to an OFF state due to the start-stop system while the compressor is in an ON state, the compressor being switched to an OFF state when the engine is switched to the OFF state;
determine whether there is an engine OFF cancel request generated to switch the engine to an ON state;
if there is a generated engine OFF cancel request, determine whether the engine OFF cancel request is due to a heating, ventilating, and air conditioning (HVAC) request; and
if the engine OFF cancel request is not due to an HVAC request, switch the engine to the ON state while the compressor remains in the OFF state.

14. The system of claim 13, wherein the memory further includes instructions that, when executed by the one or more controllers, cause the one or more controllers to:
if the engine OFF cancel request is due to an HVAC request, switch the engine to the ON state and switch the compressor to the ON state.

15. The system of claim 13, wherein the engine OFF cancel request is based on information received from one or more start-stop sensors.

16. The system of claim 15, wherein the one or more start-stop sensors include one or more of a brake sensor, a throttle sensor, a battery charge sensor, a battery temperature sensor, an engine temperature sensor, and a transmission temperature sensor.

17. The system of claim 13, wherein the HVAC request is generated based on at least one of an ambient temperature, an internal temperature, and an evaporator temperature.

18. The system of claim 17, wherein the HVAC request is generated if the evaporator temperature becomes greater than or equal to a predetermined threshold.
